(19) United States
(12) Patent Application Publication
(10) Pub. No.: US 2014/0052799 A1
(43) Pub. Date: Feb. 20, 2014

(54) GLOBALLY ADDRESSABLE INTERNET PROTOCOL AND SYNTAX MAPPING TO PHYSICAL ADDRESSES

(71) Applicant: Here, Inc., New York, NY (US)

(72) Inventor: Sean Fredrick Keane, Brooklyn, NY (US)

(73) Assignee: Here, Inc., New York, NY (US)

(21) Appl. No.: 13/966,027

(22) Filed: Aug. 13, 2013

Related U.S. Application Data
(60) Provisional application No. 61/683,079, filed on Aug. 14, 2012.

(51) Int. Cl. H04L 12/58

(52) U.S. Cl. CPC H04L 51/22
USPC 709/206

(57) ABSTRACT

Methods, systems, platforms, and software utilizing a unique addressable URI mapping to physical addresses to provide educational resources, registered electronic messaging, hyperlocal forums, micropayments, and user identity verification.

### CROSS-REFERENCE TO RELATED APPLICATIONS

This application claims the benefit of U.S. Provisional Application No. 61/683,079, filed Aug. 14, 2012, which is incorporated in its entirety herein by reference.

### BACKGROUND OF THE INVENTION

Presently, the internet and the “real” physical world exist parallel. For example, information, knowledge and data of both worlds are not well synchronized, structured, aggregated or linked. The current Internet protocol, Internet Protocol version 6 (IPv6), used to direct almost all Internet traffic, stops at the device level. In other words, a direct link between Internet users and the web of physical places, objects and entities is still missing. Moreover, many people use the internet anonymously. Verifying personal information of Internet users in order to conduct social, economic, or legal transactions is currently cumbersome and expensive.

### SUMMARY OF THE INVENTION

The design of the Internet does not allow a user-friendly and natural way to address physical world locations online. For example, the internet does not incorporate postal addresses—one of the oldest standards established by humankind. The methods, systems, and software described herein, introduce a protocol creating scalable address syntaxes that can contain elements of the physical world (such as places, individuals, businesses, vehicles, objects, etc.) in an online-processable and human-readable syntax. The protocol and syntax introduced herein rejects technical conventions such as postal codes (e.g., zip codes): It is a new approach towards a convenient standard to address the physical world.

Advantages of the methods, systems, and software described herein include, but are not limited to, a protocol design that follows a security paradigm, wherein users and services are able to adjust their visibility/public presence according to their individual demands and privacy preferences. For example, a user optionally decides to be displayed as a person living in New York; or, user optionally decides to only grant access to their identity to people living on their street. Additional advantages include the integration of space/time hashes to verify social and economic transactions. This enables secured platform transactions with the help of trusted third parties. Moreover, the protocol and syntax described herein include application programming interfaces (APIs) that facilitate the building of external applications. Contemplated applications utilizing the protocol and syntax described herein include, but are not limited to platforms, tools, and services for:

Secured online identity management;

Hyperlocal social networks built around physical street addresses;

International secure and verified messaging;

User-friendly, mobile, and trusted hyperlocal micro payments; and

Educational resources for investigating astronomical systems, objects, and bodies.

Accordingly, in one aspect, disclosed herein are computer-implemented methods for routing electronic messages associated with a physical street address comprising the steps of: providing a software module configured to access a database of physical street addresses in a computer memory; providing a software module configured to generate a unique addressable URI scheme based on each said physical street address, wherein said addressable URI scheme comprises a path further comprising elements representing a continent or region, a country, a state or province, a city, a street, a street number, and optionally a local identifier; and providing a software module for configuring a secure electronic message box addressable by said URI scheme, wherein said electronic message box is capable of receiving electronic messages associated with a physical street address. In some embodiments, the path element representing a continent or region comprises a top-level domain (TLD or base-level domain). In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the electronic message box is an email box or a secure messaging box. In some embodiments, the unique addressable URI scheme comprises user verification information. In some embodiments, the path comprises an element representing a person, place, or entity associated with the physical street address. In some embodiments, the path comprises an aggregation of time and space relationships. In some embodiments, the method further comprises the step of providing a software module configured to generate a two-dimensional bar code (e.g., quick response code or QR Code®, Datamatrix code, or High Capacity Color Barcode (HCCB)) resolving to each said addressable URI scheme. In further embodiments, a two-dimensional bar code resolving to an addressable URI scheme is accompanied by, or stands alone as, a wireless electronic identifier in the form of a radio-frequency identification (RFID) or near field communication (NFC) tag that is readable by other devices with or without user interaction, in such a case as to track the positioning of an object indoors without radio/GPS signal.

In another aspect, disclosed herein are computer-implemented systems comprising: a digital processing device comprising an operating system configured to perform executable instructions and a memory device; a computer program including instructions executable by the digital processing device to create a registered electronic message network comprising: a software module configured to access a database of physical street addresses; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a secure electronic message box addressable by said URI scheme, wherein said electronic message box is capable of receiving electronic messages associated with a physical street address. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the electronic message box is an email box or a secure messaging box. In some embodiments, the unique addressable URI scheme comprises user verification information. In some embodiments, the path comprises an element representing a person, place, or entity associated with the physical street address. In some embodiments, the path comprises an aggregation of time and space relationships. In some embodiments, the network further comprises a software module configured to generate a two-dimensional bar code resolving to each said addressable URI scheme.

In another aspect, disclosed herein are computer readable storage media encoded with a computer program including instructions executable by a digital processing device to create a registered electronic message application comprising: a software module configured to access a database of physical street addresses; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a secure electronic message box addressable by said URI scheme, wherein said electronic message box is capable of receiving electronic messages associated with a physical street address. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the electronic message box is an email box or a secure messaging box. In some embodiments, the unique addressable URI scheme comprises user verification information. In some embodiments, the path comprises an element representing a person, place, or entity associated with the physical street address. In some embodiments, the path comprises an aggregation of time and space relationships. In some embodiments, the application further comprises a software module configured to generate a two-dimensional bar code resolving to each said addressable URI scheme.

In another aspect, disclosed herein are computer-implemented methods for providing a hyperlocal forum comprising the steps of: providing a software module configured to access a database of physical street addresses in a computer memory; providing a software module configured to generate a unique addressable URI scheme based on each said physical street address, wherein said addressable URI schemes comprises a path further comprising elements representing a continent or region, a country, a state or province, a city, a street, a street number, and optionally a local identifier; and providing a software module for configuring a hyperlocal forum associated with said physical street address, wherein said forum is web-accessible by said addressable URI scheme. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the forum is a bulletin board system. In some embodiments, the forum is a wiki. In some embodiments, the path comprises an aggregation of time and space relationships. In some embodiments, the method further comprises the step of providing a software module configured to generate a two-dimensional bar code resolving to each said addressable URI scheme.

In another aspect, disclosed herein are computer-implemented systems comprising: a digital processing device comprising an operating system configured to perform executable instructions and a memory device; a computer program including instructions executable by the digital processing device to create a hyperlocal forum network comprising: a software module configured to access a database of physical street addresses; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a hyperlocal forum associated with each said physical street address, wherein said forum is web-accessible by each respective addressable URI scheme. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the hyperlocal forum is a bulletin board system. In some embodiments, the hyperlocal forum is a wiki. In some embodiments, the path comprises an aggregation of time and space relationships. In some embodiments, the network further comprises a software module configured to generate a two-dimensional bar code resolving to each said addressable URI scheme.

In another aspect, disclosed herein are computer readable storage media encoded with a computer program including instructions executable by a digital processing device to create a hyperlocal forum application comprising: a software module configured to access a database of physical street addresses in a computer memory; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a hyperlocal forum associated with said physical street address, wherein said forum is web-accessible by said addressable URI scheme. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the hyperlocal forum is a bulletin board system. In some embodiments, the hyperlocal forum is a wiki. In some embodiments, the path comprises an aggregation of time and space relationships. In some embodiments, the application further comprises a software module configured to generate a two-dimensional bar code resolving to each said addressable URI scheme.

In another aspect, disclosed herein are computer-implemented micropayment methods comprising the steps of: providing a software module allowing a user to identify a payer; providing a software module allowing a user to identify a recipient; and providing a software module for conducting a mobile payment or a micropayment between the payer and the recipient; provided that the payer and the recipient are each identified with a unique addressable URI scheme based on a physical street address, wherein said addressable URI scheme comprises a user name and a path further comprising elements representing a continent or region, a country, a state or province, a city, a street, a street number, and optionally a local identifier. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the path comprises an element representing a place or entity associated with the physical street address. In some embodiments, the path comprises an aggregation of time and space relationships.

In another aspect, disclosed herein are computer-implemented systems comprising: a digital processing device comprising an operating system configured to perform executable instructions and a memory device; a computer program including instructions executable by the digital processing device to create an micropayment network comprising: a software module allowing a user to identify a payer; a software module allowing a user to identify a recipient; and a software module for conducting a mobile payment or a micropayment between the payer and the recipient; provided that the payer and the recipient are each identified with a unique addressable URI scheme based on a physical street address, wherein said addressable URI scheme comprises a user name and a path further comprising elements representing a continent or region, a country, a state or province, a city, a street, a street number, and optionally a local identifier. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the path comprises an element representing a place or entity associated with the physical street address. In some embodiments, the path comprises an aggregation of time and space relationships.

In another aspect, disclosed herein are computer readable storage media encoded with a computer program including instructions executable by a digital processing device to create a micropayment application comprising: a software module allowing a user to identify a payer; a software module allowing a user to identify a recipient; and a software module for conducting a mobile payment or a micropayment between the payer and the recipient; provided that the payer and the recipient are each identified with a unique addressable URI scheme based on a physical street address, wherein said addressable URI scheme comprises a user name and a path further comprising elements representing a continent or region, a country, a state or province, a city, a street, a street number, and optionally a local identifier. In some embodiments, the said path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the path comprises an element representing a place or entity associated with the physical street address. In some embodiments, the path comprises an aggregation of time and space relationships.

In another aspect, disclosed herein are computer-implemented methods for verifying a user's identity comprising the step of: accessing a database of physical street addresses and users associated with each physical street address; receiving a request for verification of a user, wherein the user is identified with a unique addressable URI scheme based on a physical street address, wherein said addressable URI scheme comprises a user name and a path further comprising elements representing a continent or region, a country, a state or province, a city, a street, a street number, and optionally a local identifier; and comparing physical street address and username information from said database with information obtained from said URI scheme to verify a user's identity. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the path comprises an element representing a place or entity associated with the physical street address. In some embodiments, the path comprises an aggregation of time and space relationships.

In another aspect, disclosed herein are computer-implemented systems comprising: a digital processing device comprising an operating system configured to perform executable instructions and a memory device; a computer program including instructions executable by the digital processing device to create an user identity verification service comprising: a software module configured to access a database of physical street addresses and users associated with each physical street address; a software module configured to receive a request for verification of a user, wherein the user is identified with a unique addressable URI scheme based on a physical street address, wherein said addressable URI scheme comprises a user name and a path further comprising elements representing a continent or region, a country, a state or province, a city, a street, a street number, and optionally a local identifier; and a software module configured to compare physical street address and username information from said database with information obtained from said URI scheme to verify a user's identity. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the path comprises an element representing a place or entity associated with the physical street address. In some embodiments, the path comprises an aggregation of time and space relationships.

In another aspect, disclosed herein are computer readable storage media encoded with a computer program including instructions executable by a digital processing device to create a user identity verification application comprising: a software module configured to access a database of physical street addresses and users associated with each physical street address; a software module configured to receive a request for verification of a user, wherein the user is identified with a unique addressable URI scheme based on a physical street address, wherein said addressable URI scheme comprises a user name and a path further comprising elements representing a continent or region, a country, a state or province, a city, a street, a street number, and optionally a local identifier; and a software module configured to compare physical street address and username information from said database with information obtained from said URI scheme to verify a user's identity. In some embodiments, the path element representing a continent or region comprises a top-level domain. In further embodiments, the path element representing a continent or region comprises a .ST top-level domain. In further embodiments, the path elements representing a country, a state or province, a city, a street, and a street number comprise subdomains. In some embodiments, the continent or region is selected from the group consisting of: America, Europe, Africa, Asia, Oceania, Mideast, and Antarctica. In some embodiments, the path comprises an element representing a place or entity associated with the physical street address. In some embodiments, the path comprises an aggregation of time and space relationships.

In another aspect, disclosed herein are computer-implemented methods for providing an educational resource comprising the steps of: providing a software module configured to access a database of astronomical locations in a computer memory; providing a software module configured to generate a unique addressable URI based on each said astronomical location, wherein each said addressable URI comprises a path further comprising elements representing a universe, galaxy, star system, star, optionally a planet, and optionally a moon; and providing a software module for configuring an educational resource associated with each astronomical location, wherein each resource is web-accessible by at least one of the unique addressable URIs. In some embodiments, a unique addressable URI comprises elements representing observational data including one or more of: right ascension, declination, apparent magnitude, and constellation. In some embodiments, a path element representing a universe comprises a top-level domain. In further embodiments, a path element representing a universe comprises a .ST top-level domain. In further embodiments, the path elements representing a galaxy, star system, star, planet, and moon comprise subdomains. In some embodiments, a path comprises an element representing a place or object associated with the astronomical location. In some embodiments, the educational resource is one or more of: a wiki, a blog, a bulletin board, a message board, a report, and an article. In some embodiments, the method further comprises the step of providing a software module configured to generate a two-dimensional bar code resolving to each said addressable URI.

In another aspect, disclosed herein are computer-implemented systems comprising: a digital processing device comprising an operating system configured to perform executable instructions and a memory device; a computer program including instructions executable by the digital processing device to create an educational resource comprising: a software module configured to access a database of astronomical locations in a computer memory; a software module configured to generate a unique addressable URI based on each said astronomical location, wherein each said addressable URI comprises a path further comprising elements representing a universe, galaxy, star system, star, optionally a planet, and optionally a moon; and a software module for configuring an educational resource associated with each astronomical location, wherein each resource is web-accessible by at least one of the unique addressable URIs. In some embodiments, a unique addressable URI comprises elements representing observational data including one or more of: right ascension, declination, apparent magnitude, and constellation. In some embodiments, a path element representing a universe comprises a top-level domain. In further embodiments, a path element representing a universe comprises a .ST top-level domain. In further embodiments, the path elements representing a galaxy, star system, star, planet, and moon comprise subdomains. In some embodiments, a path comprises an element representing a place or object associated with the astronomical location. In some embodiments, the educational resource is one or more of: a wiki, a blog, a bulletin board, a message board, a report, and an article. In some embodiments, the educational resource further comprises a software module configured to generate a two-dimensional bar code resolving to each said addressable URI.

In another aspect, disclosed herein are computer readable storage media encoded with a computer program including instructions executable by a digital processing device to create an educational resource application comprising: a software module configured to access a database of astronomical locations in a computer memory; a software module configured to generate a unique addressable URI based on each said astronomical location, wherein each said addressable URI comprises a path further comprising elements representing a universe, galaxy, star system, star, optionally a planet, and optionally a moon; and a software module for configuring an educational resource associated with each astronomical location, wherein each resource is web-accessible by at least one of the unique addressable URIs. In some embodiments, a unique addressable URI comprises elements representing observational data including one or more of: right ascension, declination, apparent magnitude, and constellation. In some embodiments, a path element representing a universe comprises a top-level domain. In further embodiments, a path element representing a universe comprises a .ST top-level domain. In further embodiments, the path elements representing a galaxy, star system, star, planet, and moon comprise subdomains. In some embodiments, a path comprises an element representing a place or entity associated with an astronomical location. In some embodiments, the educational resource is one or more of: a wiki, a blog, a bulletin board, a message board, a report, and an article. In some embodiments, the educational resource application further comprises a software module configured to generate a two-dimensional bar code resolving to each said addressable URI.

### BRIEF DESCRIPTION OF THE DRAWINGS

FIG. 1 shows a non-limiting example of a protocol for addressing a location; in this case, an addressable URI scheme including a path with elements identifying a particular physical street address.

FIG. 2 shows a non-limiting example of a protocol for addressing a location; in this case, an addressable URI scheme including a path with elements identifying a space within a particular physical street address and an entity associated with the physical street address.

FIG. 3 shows a non-limiting example of a protocol for addressing a user associated with a location; in this case, an addressable URI including a particular user and a path with elements identifying a particular physical street address.

FIG. 4 shows a non-limiting example of a protocol for addressing a user associated with a location; in this case, an addressable URI including a particular user and a path with elements identifying a particular physical street address and a local identifier associated with the physical street address.

FIG. 5 shows a non-limiting example of a process flow for a registered, electronic messaging network.

FIG. 6 shows a non-limiting example of an anonym (e.g., pseudonym) secured verified key; in this case, a key including verified user data as well as an aggregation of time/space relationships.

FIG. 7 shows a non-limiting example of a protocol for addressing an astronomical location; in this case, an addressable URI including a path with elements identifying a particular object associated with a location in space.

### DETAILED DESCRIPTION OF THE INVENTION

Prior Internet addressing protocols and applications fail to offer schema for addressing persons, places, entities, and objects in the physical world. There is a long-felt and unmet need for an addressable URI scheme based on physical street addresses. As a result, there is currently a dearth of applications that allow identification of aspects of the physical world to perform vital functions.

Described herein, in various embodiments, are computer-implemented methods for routing electronic messages associated with a physical street address comprising the steps of: providing a software module configured to access a database of physical street addresses in a computer memory; providing a software module configured to generate a unique addressable URI scheme based on each said physical street address, wherein said addressable URI scheme comprises a path further comprising elements representing a continent or region, a country, a state or province, a city, a street, a street number, and optionally a local identifier; and providing a software module for configuring a secure electronic message box addressable by said URI scheme, wherein said electronic message box is capable of receiving electronic messages associated with a physical street address.

Also described herein, in various embodiments, are computer-implemented systems comprising: a digital processing device comprising an operating system configured to perform executable instructions and a memory device; a computer program including instructions executable by the digital processing device to create a registered electronic message network comprising: a software module configured to access a database of physical street addresses; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a secure electronic message box addressable by said URI scheme, wherein said electronic message box is capable of receiving electronic messages associated with a physical street address.

Also described herein, in various embodiments, are computer readable storage media encoded with a computer program including instructions executable by a digital processing device to create a registered electronic message application comprising: a software module configured to access a database of physical street addresses; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a secure electronic message box addressable by said URI scheme, wherein said electronic message box is capable of receiving electronic messages associated with a physical street address.

Also described herein, in various embodiments, are computer-implemented methods for providing a hyperlocal forum comprising the steps of: providing a software module configured to access a database of physical street addresses in a computer memory; providing a software module configured to generate a unique addressable URI scheme based on each said physical street address, wherein said addressable URI schemes comprises a path further comprising elements representing a continent or region, a country, a state or province, a city, a street, a street number, and optionally a local identifier; and providing a software module for configuring a hyperlocal forum associated with said physical street address, wherein said forum is web-accessible by said addressable URI scheme.

Also described herein, in various embodiments, are computer-implemented systems comprising: a digital processing device comprising an operating system configured to perform executable instructions and a memory device; a computer program including instructions executable by the digital processing device to create a hyperlocal forum network comprising: a software module configured to access a database of physical street addresses; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a hyperlocal forum associated with each said physical street address, wherein said forum is web-accessible by each respective addressable URI scheme.

Also described herein, in various embodiments, are computer readable storage media encoded with a computer program including instructions executable by a digital processing device to create a hyperlocal forum application comprising: a software module configured to access a database of physical street addresses in a computer memory; a software module configured to generate a unique addressable URI scheme based on each said physical street address, wherein each said addressable URI scheme comprises a path further comprising elements representing a continent or region, a country, a state or province, a city, a street, a street number, and optionally a local identifier; and a software module for configuring a hyperlocal forum associated with said physical street address, wherein said forum is web-accessible by said addressable URI scheme.

Also described herein, in various embodiments, are computer-implemented micropayment methods comprising the steps of: providing a software module allowing a user to identify a payer; providing a software module allowing a user to identify a recipient; and providing a software module for conducting a mobile payment or a micropayment between the payer and the recipient; provided that the payer and the recipient are each identified with a unique addressable URI scheme based on a physical street address, wherein said addressable URI scheme comprises a user name and a path further comprising elements representing a continent or region, a country, a state or province, a city, a street, a street number, and optionally a local identifier.

Also described herein, in various embodiments, are computer-implemented systems comprising: a digital processing device comprising an operating system configured to perform executable instructions and a memory device; a computer program including instructions executable by the digital processing device to create an micropayment network comprising: a software module allowing a user to identify a payer; a software module allowing a user to identify a recipient; and a software module for conducting a mobile payment or a micropayment between the payer and the recipient; provided that the payer and the recipient are each identified with a unique addressable URI scheme based on a physical street address, wherein said addressable URI scheme comprises a user name and a path further comprising elements representing a continent or region, a country, a state or province, a city, a street, a street number, and optionally a local identifier.

Also described herein, in various embodiments, are computer readable storage media encoded with a computer program including instructions executable by a digital processing device to create a micropayment application comprising: a software module allowing a user to identify a payer; a software module allowing a user to identify a recipient; and a software module for conducting a mobile payment or a micropayment between the payer and the recipient; provided that the payer and the recipient are each identified with a unique addressable URI scheme based on a physical street address, wherein said addressable URI scheme comprises a user name and a path further comprising elements representing a continent or region, a country, a state or province, a city, a street, a street number, and optionally a local identifier.

Also described herein, in various embodiments, are computer-implemented methods for verifying a user's identity comprising the step of: accessing a database of physical street addresses and users associated with each physical street address; receiving a request for verification of a user, wherein the user is identified with a unique addressable URI scheme based on a physical street address, wherein said addressable URI scheme comprises a user name and a path further comprising elements representing a continent or region, a country, a state or province, a city, a street, a street number, and optionally a local identifier; and comparing physical street address and username information from said database with information obtained from said URI scheme to verify a user's identity.

Also described herein, in various embodiments, are computer-implemented systems comprising: a digital processing device comprising an operating system configured to perform executable instructions and a memory device; a computer program including instructions executable by the digital processing device to create an user identity verification service comprising: a software module configured to access a database of physical street addresses and users associated with each physical street address; a software module configured to receive a request for verification of a user, wherein the user is identified with a unique addressable URI scheme based on a physical street address, wherein said addressable URI scheme comprises a user name and a path further comprising elements representing a continent or region, a country, a state or province, a city, a street, a street number, and optionally a local identifier; and a software module configured to compare physical street address and username information from said database with information obtained from said URI scheme to verify a user's identity.

Also described herein, in various embodiments, are computer readable storage media encoded with a computer program including instructions executable by a digital processing device to create a user identity verification application comprising: a software module configured to access a database of physical street addresses and users associated with each physical street address; a software module configured to receive a request for verification of a user, wherein the user is identified with a unique addressable URI scheme based on a physical street address, wherein said addressable URI scheme comprises a user name and a path further comprising elements representing a continent or region, a country, a state or province, a city, a street, a street number, and optionally a local identifier; and a software module configured to compare physical street address and username information from said database with information obtained from said URI scheme to verify a user's identity.

Also described herein, in various embodiments, are computer-implemented methods for providing an educational resource comprising the steps of: providing a software module configured to access a database of astronomical locations in a computer memory; providing a software module configured to generate a unique addressable URI based on each said astronomical location, wherein each said addressable URI comprises a path further comprising elements representing a universe, galaxy, star system, star, optionally a planet, and optionally a moon; and providing a software module for configuring an educational resource associated with each astronomical location, wherein each resource is web-accessible by at least one of the unique addressable URIs.

Also described herein, in various embodiments, are computer-implemented systems comprising: a digital processing device comprising an operating system configured to perform executable instructions and a memory device; a computer program including instructions executable by the digital processing device to create an educational resource comprising: a software module configured to access a database of astronomical locations in a computer memory; a software module configured to generate a unique addressable URI based on each said astronomical location, wherein each said addressable URI comprises a path further comprising elements representing a universe, galaxy, star system, star, optionally a planet, and optionally a moon; and a software module for configuring an educational resource associated with each astronomical location, wherein each resource is web-accessible by at least one of the unique addressable URIs.

Also described herein, in various embodiments, are computer readable storage media encoded with a computer program including instructions executable by a digital processing device to create an educational resource application comprising: a software module configured to access a database of astronomical locations in a computer memory; a software module configured to generate a unique addressable URI based on each said astronomical location, wherein each said addressable URI comprises a path further comprising elements representing a universe, galaxy, star system, star, optionally a planet, and optionally a moon; and a software module for configuring an educational resource associated with each astronomical location, wherein each resource is web-accessible by at least one of the unique addressable URIs.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “hyperlocal” means having the character of being oriented around a well defined community. For example, in some cases, the primary focus is directed toward the concerns of residents of a particular locality. In other cases, the primary focus is directed toward the concerns of members of a particular group or organization associated with a particular locality. In yet other cases, the primary focus is directed toward the concerns of employees of a particular business or entity associated with a particular locality.

### Database of Addresses

In some embodiments, the methods, systems, software, applications, networks, and platforms disclosed herein include a database of addresses, or use of the same. In further embodiments, a database of addresses is a database of physical street addresses. An address is, for example, a collection of information, presented in a locally standardized format. An address describes, for example, the location of a building, apartment, facility, or other structure or a plot of land, generally using political boundaries and street names as references, along with other identifiers such as house or apartment numbers. Some addresses also contain codes to aid routing of mail and packages, such as a ZIP code.

In some embodiments, a database of addresses comprises addresses based on building (e.g., house) numbering. In further embodiments, buildings are numbered using a standard utilizing an alternating numbering scheme progressing in one direction along a street. In still further embodiments, buildings are numbered with odd numbers on one side of a street and even numbers on the other. In other embodiments, buildings are numbered using alternative schemes.

In some embodiments, a database of addresses comprises addresses based on a Cartesian-coordinate-based system (e.g., quadrants). In further embodiments, streets that form the north-south and east-west dividing lines constitute the x and y-axes of a Cartesian coordinate plane and divide a city into quadrants. In still further embodiments, quadrants are identified in street names. For example, streets in a northeast quadrant may have “NE” prefixed or suffixed to their street names.

In some embodiments, a database of addresses comprises addresses based on street naming conventions. Many street naming conventions are suitable. In some embodiments, streets are numbered sequentially across a street grid. In some embodiments, lettered or alphabetically named sequentially across a street grid. In further embodiments, diagonal avenues are named differently than streets following a grid pattern. In other embodiments, streets are named, for example, after famous people, meaningful dates, plants, animals, states, and the like.

In some embodiments, a database of addresses comprises addresses comprising a postal code (e.g., numeric or alphanumeric codes). In other embodiments, a database of addresses comprises addresses that do not include a postal code.

In some embodiments, a database of addresses comprises a combination of the types of addresses described herein.

In some embodiments, the methods, systems, software, applications, networks, and platforms disclosed herein include a software module configured to access one or more databases of addresses in computer memory. In some embodiments, a software module configured to access a database of addresses in a computer memory, connects to a database. In some embodiments, a database is local. In other embodiments, a database is remote. In some embodiments, a software module configured to access one or more databases of addresses in computer memory accesses one database. In other embodiments, a software module configured to access one or more databases of addresses in computer memory accesses a plurality of databases. In various embodiments, a software module configured to access one or more databases of addresses in computer memory accesses, 2, 3, 4, 5, 6, 7, 8, 9, 10, 20, 30, 40, 50, 60, 70, 80, 90, 100, 150, 200, 250, 300, 350, 400, 450, 500 or more databases, including increments therein.

In view of the disclosure provided herein, those of skill in the art will recognize that many databases are suitable for storage and retrieval of addresses. In various embodiments, suitable databases include, by way of non-limiting examples, relational databases, non-relational databases, object oriented databases, object databases, entity-relationship model databases, associative databases, and XML databases. In some embodiments, a database of addresses in a computer memory is internet-based. In further embodiments, a database of addresses in a computer memory is web-based. In still further embodiments, a database of addresses in a computer memory is cloud computing-based. In other embodiments, a database of addresses in a computer memory is based on one or more local computer storage devices.

Suitable databases of addresses are complied, created, and/or maintained by a variety of entities and organizations. In some embodiments, one or more databases of addresses are publicly accessible. In some embodiments, one or more databases of addresses are private. In further embodiments, a private database is secure and/or protected. In some embodiments, one or more databases of addresses are complied, created, and/or maintained by a government or a government entity, agency, administration, or department. In further embodiments, a database of addresses is complied, created, and/or maintained by a postal service or agency. In other embodiments, one or more databases of addresses are complied, created, and/or maintained by a non-governmental organization. In some embodiments, one or more databases of addresses are complied, created, and/or maintained by a business, such as a corporation, a partnership, or a limited liability company. In further embodiments, a database of addresses is complied, created, and/or maintained by a healthcare organization. In some embodiments, one or more databases of addresses are complied, created, and/or maintained by a non-profit, a not for profit, or a public benefit organization. In further embodiments, a database of addresses is complied, created, and/or maintained by a religious organization. In other embodiments, one or more databases of addresses are complied, created, and/or maintained by an individual.

In some embodiments, a software module configured to access a database of addresses in a computer memory, for example, reads and/or obtains addresses from a database. In some embodiments, a software module configured to access a database of addresses in a computer memory, for example, writes, moves, and/or transfers addresses to a database. In some embodiments, a software module configured to access a database of addresses in a computer memory, for example, edits addresses within a database. In some embodiments, a software module configured to access a database of addresses in a computer memory, for example, deletes addresses from a database.

Many address formats are suitable. In some embodiments, one or more addresses are written starting with the most specific (e.g., granular) information to the most general (e.g., coarse) information. In further embodiments, one or more addresses include, by way of non-limiting examples, name, company name, street number, street, floor, apartment/unit/suite number, city, area/district/locality, town/village/parish, county, state/province/municipality, and postal code (e.g., postcode, ZIP code, etc.). In view of the disclosure provided herein, those of skill in the art will recognize that the components or elements of an address are suitably used in a variety or orders and configurations.

### Database of Astronomical Locations

In some embodiments, the methods, systems, software, applications, networks, and platforms disclosed herein include a database of astronomical locations, or use of the same. In further embodiments, a database of astronomical locations is a database of locations of astronomical objects. A location of an astronomic object describes, by way of non-limiting examples, the location of a galaxy, super cluster of stars, cluster of stars, star system, star, planet system, planet, moon, asteroid, or other object/body.

In some embodiments, a database of astronomical locations comprises locations based on the hierarchical organization of astronomical objects. In some embodiments, a database of astronomical locations comprises locations based on the position of an astronomical object relative to other nearby astronomical objects. In other embodiments, a database of astronomical locations comprises locations based on Earth-relative observational data. In further embodiments, a database of astronomical locations comprises locations based on observational data including, by way of non-limiting examples, right ascension, declination, apparent magnitude, and constellation. In further embodiments, a database of astronomical locations comprises locations based on distance from Earth. In still further embodiments, distance from Earth is measured in, for example, astronomical units (AU).

In some embodiments, the methods, systems, software, applications, networks, and platforms disclosed herein include a software module configured to access one or more databases of astronomical locations in computer memory. In some embodiments, a software module configured to access a database of astronomical locations in a computer memory, connects to a database. In some embodiments, a database is local. In other embodiments, a database is remote. In some embodiments, a software module configured to access one or more databases of astronomical locations in computer memory accesses one database. In other embodiments, a software module configured to access one or more databases of astronomical locations in computer memory accesses a plurality of databases. In various embodiments, a software module configured to access one or more databases of astronomical locations in computer memory accesses, 2, 3, 4, 5, 6, 7, 8, 9, 10, 20, 30, 40, 50, 60, 70, 80, 90, 100, 150, 200, 250, 300, 350, 400, 450, 500 or more databases, including increments therein.

In view of the disclosure provided herein, those of skill in the art will recognize that many databases are suitable for storage and retrieval of astronomical locations. In various embodiments, suitable databases include, by way of non-limiting examples, relational databases, non-relational databases, object oriented databases, object databases, entity-relationship model databases, associative databases, and XML databases. In some embodiments, a database of astronomical locations in a computer memory is internet-based. In further embodiments, a database of astronomical locations in a computer memory is web-based. In still further embodiments, a database of astronomical locations in a computer memory is cloud computing-based. In other embodiments, a database of astronomical locations in a computer memory is based on one or more local computer storage devices.

Suitable databases of astronomical locations are complied, created, and/or maintained by a variety of entities and organizations. In some embodiments, one or more databases of astronomical locations are publicly accessible. In some embodiments, one or more databases of astronomical locations are private. In further embodiments, a private database is secure and/or protected. In some embodiments, one or more databases of astronomical locations are complied, created, and/or maintained by a government or a government entity, agency, administration, or department. In further embodiments, one or more databases of astronomical locations are complied, created, and/or maintained by a military entity, agency, administration, or department. In other embodiments, one or more databases of astronomical locations are complied, created, and/or maintained by a non-governmental organization. In some embodiments, one or more databases of astronomical locations are complied, created, and/or maintained by a business, such as a corporation, a partnership, or a limited liability company. In some embodiments, one or more databases of astronomical locations are complied, created, and/or maintained by a non-profit, a not for profit, or a public benefit organization. In further embodiments, a database of astronomical locations is complied, created, and/or maintained by a religious organization. In other embodiments, one or more databases of astronomical locations are complied, created, and/or maintained by an individual.

### URI Protocol and Syntax Based on Address

In some embodiments, the methods, systems, software, applications, networks, and platforms disclosed herein include a software module configured to generate unique addressable URIs based on addresses, or use of the same. In some embodiments, the software module generates unique addressable URIs based on physical street addresses. In further embodiments, each unique addressable URI is based on a unique physical street address. In such cases, each URI generated is uniquely associated with a physical street address.

In some embodiments, an addressable URI comprises a path. In further embodiments, an addressable URI comprises a path further comprising elements representing parts of an address. In still further embodiments, an addressable URI comprises a path further comprising elements representing parts of an address including, by way of non-limiting examples, continent, region, country, state, province, municipality, county, city, town, village, parish, area, district, locality, street number, street, and floor. In a particular embodiment, an addressable URI comprises a path further comprising elements representing parts of an address including a continent or region, a country, a state or province, a city, a street, and a street number. In some embodiments, an addressable URI comprises a path further comprising a local identifier representing, for example, a place, entity, room, position, or object.

In some embodiments, an addressable URI comprises a TLD. A TLD is one of the domains at the highest level in the hierarchical Domain Name System of the internet. Many TLDs are suitable. In various embodiments, suitable TLDs include, for example, country-code TLDs, internationalized country code TLDs, generic TLDs (gTLDs) including sponsored TLDs and unsponsored TLDs, USA TLDs, and infrastructure TLDs. In further embodiments, suitable USA TLDs include, by way of non-limiting examples, .edu, .gov, and .mil. In further embodiments, suitable country-code TLDs include, by way of non-limiting examples, .ac, .ad, .ae, .af, .ag, .ai, .al, .am, .an, .ao, .aq, .ar, .as, .at, .au, .aw, .ax, .az, .ba, .bb, .bd, .be, .bf, .bg, .bh, .bi, .bj, .bm, .bn, .bo, .br, .bs, .bt, .by, .bw, .by, .bz, .ca, .cc, .cd, .cf, .cg, .ch, .ci, .ck, .cl, .cm, .cn, .co, .cr, .cs, .cu, .cv, .cx, .cy, .cz, .dd, .de, .dj, .dk, .dm, .do, .dz, .ec, .ee, .eg, .eh, .er, .es, .et, .eu, .fi, .fj, .fk, .fm, .fo, .fr, .ga, .gb, .gd, .ge, .gf, .gg, .gh, .gi, .gl, .gm, .gn, .gp, .gq, .gr, .gs, .gt, .gu, .gw, .gy, .hk, .hm, .hn, .hr, .ht, .hu, .id, .ie, .il, .im, .in, .io, .iq, .ir, .is, .it, je. jm, .jo, .jp, .ke, .kg, .kh, .ki, .km, .kn, .kp, .kr, .kw, .ky, .kz, .la, .lb, .lc, .lk, .lr, .ls, .lt, .lu, .lv, .ma, .mc, .md, .me, .mg, .mh, .mk, .ml, .mm, .mn, .mo, .mp, .mq, .mr, .ms, .mt, .mu, .mv, .mw, .mx, .my, .mz, .na, .nc, .ne, .nf, .ng, .ni, .nl, .no, .np, .nr, .nu, .nz, .om, .pa, .pe, .pf, .pg, .ph, .pk, .pl, .pm, .pn, .pr, .ps, .pt, .pw, .py, .qa, .re, .ro, .rs, .ru, .rw, .sa, .sb, .sc, .sd, .se, .sg, .sh, .si, .sj, .sk, .sl, .sm, .sn, .so, .sr, .ss, .st, .su, .sv, .sy, .sz, .tc, .td, .tf, .tg, .th, .tj, .tk, .tl, .tm, .tn, .to, .tp, .tr, .tt, .tv, .tw, .tz, .ua, .ug, .uk, .us, .uy, .uz, .va, .vc, .ve, .vg, .vi, .vn, .wf, .ws, .ye, .yt, .yu, .za, .zm, and .zw. In further embodiments, suitable gTLDs include, by way of non-limiting examples, .aero, .asia, .biz, .cat, .com, .coop, .info, .int, .jobs, .mobi, .museum, .name, .net, .org, .pro, .tel, and .travel.

In still further embodiments, a TLD is a new gTLD. In further embodiments, a TLD is a new gTLD established under a program offered by the Internet Corporation for Assigned Names and Numbers (ICANN). Many new gTLDs are available and any are suitable for use with the methods, systems, software, applications, networks, and platforms disclosed herein. In some embodiments, a new gTLD is chosen to indicate or communicate the functionality offered via the domain. Non-limiting examples, of new gTLDs based on functionality are described in Table 1.

TABLE 1
Exemplary new gTLDs.

| New gTLD | Exemplary Functionality |
|---|---|
| .map, .where, .st, .o | Physical address location |
| .social, .here, .local | Local social networking and forums |
| .mail, .post, .message | Verified electronic messaging |
| .identity, .who, .person | Identity verification |
| .pay, .wire, .money | Micropayments |

In some embodiments, a TLD in conjunction with a second-level domain is used to represent the most general part of an address. In further embodiments, a TLD in conjunction with a second-level domain is used to represent a continent or region. In various embodiments, a TLD in conjunction with a second-level domain is used to represent continents and/or regions including, by way of non-limiting examples, America, North America, South America, Europe, Africa, Asia, Oceania, Australia, Mideast, and Antarctica. For example, as exemplified in FIGS. 1-4, the second-level domain-TLD combination “america.st” represents the continent associated with some physical street addresses.

In some embodiments, a TLD in conjunction with a second-level domain is used to represent a country. In further embodiments, a second-level domain is a standardized two-letter or a three-letter country code. For example the second-level domain-TLD combinations “us.st” and “usa.st” represent the country associated with some physical street addresses.

In some embodiments, an addressable URI comprises one or more secondary domains and/or subdomains. In further embodiments, one or more secondary domains and/or subdomains are based on and/or represent parts of an address. In still further embodiments, elements of a physical street address are represented by, for example, second-level, third-level, fourth-level, fifth-level, sixth-level, seventh-level, eighth-level, ninth-level, tenth-level, eleventh-level, twelfth-level, thirteenth-level, fourteenth-level, fifteenth-level, sixteenth-level, seventeenth-level, eighteenth-level, nineteenth-level, twentieth-level or higher domains and/or subdomains. In various embodiments, an addressable URI described herein comprises 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 or more secondary domains and/or subdomains. In some embodiments, the levels of domains correspond to layers of specificity in an address that the path is based on and/or represents.

Referring to FIG. 1, in a particular non-limiting embodiment, a software module generates a unique addressable URI based on the physical street address: 345 Eldert Street, Apartment 309, Brooklyn, N.Y., United States of America. In this embodiment, the URI comprises the TLD (e.g., base domain, first-level domain etc.) “.st.” Further in this embodiment, the URI comprises elements (e.g., domains) representing the continent (e.g., “america,” a second-level domain), the country (e.g., “us,” a third-level domain), the state (e.g., “ny,” a fourth-level domain), the city (e.g., “brooklyn,” a fifth-level domain), the street (e.g., “eldert.st,” sixth and seventh-level domains), the street number (e.g., “345,” an eighth-level domain), and the apartment number (e.g., “309,” a ninth-level domain).

In some embodiments, the elements of a unique addressable URI form a rigid hierarchy to facilitate predictability in translating between the URI and the address on which it is based. In other embodiments, the elements of a unique addressable URI form a flexible hierarchy, wherein elements may be used in multiple orders or in different parts of the URI or path. In further embodiments, a flexible hierarchy allows integration of a multitude of cultural conventions. In still further embodiments, a flexible hierarchy improves human readability of the URI. For example, in some addresses, an apartment number follows a street name (even though apartment is a higher level of specificity than street number and name) and a URI based on such an address has elements ordered as follows:

http://345.eldert.st.apt.309.brooklyn.ny.us.america.st.

In some cases, the URI above is preferred to:

http://309.345.eldert.st.brooklyn.ny.us.america.st.

In such cases, the preference is due to the fact that the later incorporates U.S. envelope addressing conventions and therefore improves human readability. By way of further example, a particular individual at the same address is optionally addressed by the URI:

sean.kean@345.eldert.st.apt.309.brooklyn.ny.us.america.st.

In further embodiments, a flexible hierarchy allows integration of some European addressing conventions. For example, in some European addresses, house number follows street name and a URI based on such an address has elements ordered as follows:

http://sollerodgade.42.norrebro.cph.dk.europe.st.

By way of further example, a particular individual at the same address is optionally addressed by the URI:

sean.kean@sollerodgade.42.norrebro.cph.dk.europe.st.

In further embodiments, a flexible hierarchy allows integration of some Japanese addressing conventions. For example, some Japanese addresses include the house by block and lot number, rather than lot and block, and a URI based on such an address has elements ordered as follows:

http://11-4.maruyamacho.shibuya.tokyojp.asia.st.

In such cases, the hierarchy incorporates Japanese envelope addressing conventions and therefore improves human readability. By way of further example, a particular individual at the same address is optionally addressed by the URI:

sean.kean@11-4.maruyamacho.shibuya.tokyo.jp.asia.st.

Again referring to FIG. 1, the hierarchy of the URI formed by the TLD and second-level through ninth-level domains creates a scalable specificity. In other words, in some embodiments, a software module generates a unique addressable URI based on an address with a variable degree of specificity. In various embodiments, a unique addressable URI represents addressing at the continental, national, regional, local, or hyperlocal degree of specificity. For example, in some cases, a software module generates a unique addressable URI based on and/or representing a physical street address specifying a particular apartment in a building. In other cases, by omitting, for example, an apartment number element, a URI is based on and/or represents all apartments in the building.

In some embodiments, a software module generates a unique addressable URI comprising a local identifier. In some embodiments, a local identifier enables a URI to address items (e.g., places, persons, things, entities, objects) associated with a physical street address with a high level of specificity. In some embodiments, a local identifier is implemented as a domain or a subdomain of a URI. In some embodiments, a local identifier is implemented as a directory, folder, or file name added to a URI path and separated by a forward-slash. In further embodiments, directory and file elements are based on and/or represent parts of an address and are formatted, by way of non-limiting examples, as “/directory,” “/directory/directory,” and “/directory/file.” In some embodiments, the directories, folders, and file in a path correspond to layers of specificity in an address that the path is based on and/or represents.

In a particular embodiment, a local identifier enables a URI to address an object associated with a physical street address in order to programmatically reference components, elements, sensors, actuators, appliances, infrastructure, and the like. In some cases URIs addressing objects associated with an address are used in home/retail automation applications. In one example, an appliance associated with an address is powered on via the web by accessing the following URI:

http://345.eldert.apt.309.brooklyn.ny.us.america.st/kitchen/coffee.machine/on.

In another example, the infrastructure of a building is referenced by the following URI:

http://345.eldert.apt.309.brooklyn.ny.us.america.st/bathroom/light/off.

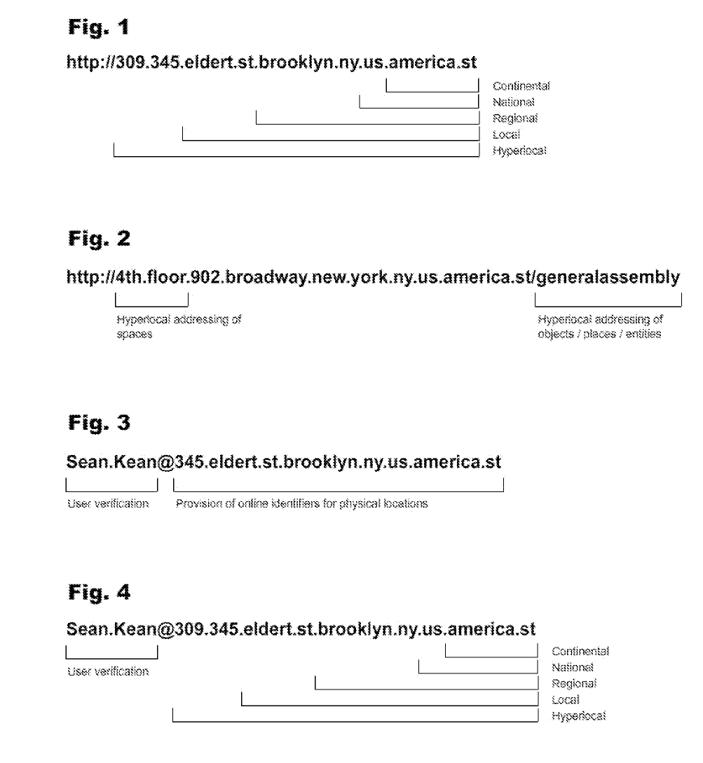

Referring to FIG. 2, in a particular non-limiting embodiment, an addressable URI includes elements representing hyperlocal addressing of a space associated with a physical street address and an entity associated with a physical street address. For example, the space “4th.floor” is represented by a combination of ninth and tenth-level domains and the entity “generalassembly” (or General Assembly) is represented by a directory element.

In some embodiments, a software module generates a unique addressable URI is based on an institutional address. For example, an institutional postal address of: Anna Mueller, Attn: Kinect Accelerator (SEA-320WESTLAKE/3665), Microsoft Corporation, One Microsoft Way, Redmond, Wash. 98052 is represented as, in some embodiments, by the unique addressable URI: http://1.microsoft.way.redmond.wa.us.america.st/microsoft.corporation/sea/320westlake/3665.

In some embodiments, a unique addressable URI comprises user information. In further embodiments, a unique addressable URI comprises a name or username. In some embodiments, a name or username is for an individual. In some embodiments, a name or username is for a group. In other embodiments, a name or username is for an organization, an entity, a company, or the like. Many formats are suitable for a username. In the case of an individual, suitable usernames include first name (e.g., Sean), last name (e.g., Kean), first initial and last name (e.g., SKean), first name and last name (e.g., SeanKean or Sean.Kean), or the like. In some embodiments, a user identified by user verification information is associated with the physical street that the URI is based on and/or represents. In such cases, a unique addressable URI specifies a particular individual, group, organization, entity, company, or the like associated with a particular physical street address.

Referring to FIG. 3, in a particular non-limiting embodiment, a software module generates a unique addressable URI based on the physical street address: 345 Eldert Street, Brooklyn, N.Y., United States of America. In this embodiment, the URI comprises user verification information, the username “Sean.Kean,” at the front of the URI, separated by the at sign (e.g., @). Further in this embodiment, a unique addressable URI is based on and represents an individual associated with a physical street address.

In some embodiments, a URI comprising user information combined with the hierarchy of the URI formed by the TLD and secondary domains representing elements of a physical street address creates a scalable privacy model. In other words, in some embodiments, a software module generates a unique addressable URI based on user and address information with a variable degree of privacy. For example, in various embodiments, a URI described herein optionally identifies a user as a resident of a particular apartment, a particular building, a particular city, a particular county, a particular state, a particular region, or a particular country.

Referring to FIG. 4, in a particular non-limiting embodiment, a software module generates a unique addressable URI based on the physical street address: 345 Eldert Street, Apartment 309, Brooklyn, N.Y., United States of America. In this embodiment, the URI further comprises user verification information in the form of a username for a particular individual associated with the address, Sean Kean. In this case, the user is identified as a resident of a particular apartment in a particular building.

The hierarchy of the URI formed by the TLD and first-level through eighth-level domains creates a scalable privacy model. In other embodiments, a user optionally omits, for example, an apartment number element and is identified only as a resident of a particular building. In yet other embodiments, a user optionally omits, for example, an apartment number element, a street element, and a street number element and is identified only as a resident of a particular city. In various embodiments, a scalable privacy model optionally allows identification of a user at a continental, national, regional, local, or hyperlocal level.

In some embodiments, the methods, systems, software, applications, networks, and platforms disclosed herein include a software module configured to generate unique addressable URIs based on addresses, that are human-readable. In further embodiments, the unique addressable URIs described herein are readable by a human to obtain or understand the physical street addresses on which the URI is based. In some cases where the URI includes user verification information, the URIs described herein are also readable by a human to obtain or understand the identity of the user described.

### URI Protocol and Syntax Based on Astronomical Location

In some embodiments, the methods, systems, software, applications, networks, and platforms disclosed herein include a software module configured to generate unique addressable URIs based on astronomical locations, or use of the same. In some embodiments, the software module generates unique addressable URIs based on the locations of astronomical objects. In further embodiments, each unique addressable URI is based on a unique location of an astronomical object. In such cases, each URI generated is uniquely associated with an object/body in space.

In some embodiments, an addressable URI comprises a path. In further embodiments, an addressable URI comprises a path further comprising elements representing parts of an astronomical location. In further embodiments, an addressable URI comprises a path further comprising elements representing parts of an astronomical location including, by way of non-limiting examples, universe, galaxy, super cluster of stars, cluster of stars, star, planet system, planet, moon, asteroid, and other object/body. In some embodiments, an addressable URI comprises a path further comprising a local identifier representing, for example, a planetary ring or satellite.

In some embodiments, an addressable URI comprises a TLD, such as those described herein. In still further embodiments, a TLD is a new gTLD. In some embodiments, a TLD in conjunction with a second-level domain is used to represent the most general part of an astronomical location. In further embodiments, a TLD in conjunction with a second-level domain is used to represent a universe. In other embodiments, a TLD in conjunction with a second-level domain is used to represent a galaxy, star cluster, star system, constellation, star, planetary system, planet, or region/sector of space. For example, as exemplified in FIG. 7, the second-level domain-TLD combination “universe.st” represents observable reality.

In some embodiments, a TLD in conjunction with a second-level and third-level domain is used to represent a galaxy. For example the third-level domain, second-level domain, and TLD combination “milkyway.universe.st” represents the Milky Way galaxy, the galaxy that contains the Earth. In some embodiments, a TLD in conjunction with a second-level, third-level domain, and fourth-level domain is used to represent a galaxy. For example the fourth-level domain, third-level domain, second-level domain, and TLD combination “milky.way.universe.st” represents the Milky Way galaxy, the galaxy that contains the Earth.

In some embodiments, an addressable URI comprises one or more secondary domains and/or subdomains. In further embodiments, one or more secondary domains and/or subdomains are based on and/or represent parts of an astronomical location. In still further embodiments, elements of an astronomical location are represented by, for example, second-level, third-level, fourth-level, fifth-level, sixth-level, seventh-level, eighth-level, ninth-level, tenth-level, eleventh-level, twelfth-level, thirteenth-level, fourteenth-level, fifteenth-level, sixteenth-level, seventeenth-level, eighteenth-level, nineteenth-level, twentieth-level or higher domains and/or subdomains. In various embodiments, an addressable URI described herein comprises 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 or more secondary domains and/or subdomains. In some embodiments, the levels of domains correspond to layers of specificity in an astronomical location that the path is based on and/or represents.

Referring to FIG. 7, in a particular embodiment, a software module generates a unique addressable URI based on the astronomical location of Nu Scorpii, a star system in the constellation Scorpius. By way of non-limiting example, a unique URI addressing the location of this astronomical system is:

http://c.nu.scorpii.scorpius.milky.way.universe.st.

Again referring to FIG. 7, the hierarchy of the URI formed by the TLD and second-level through eighth-level domains creates a scalable specificity. In other words, in some embodiments, a software module generates a unique addressable URI based on an astronomical location with a variable degree of specificity. In various embodiments, a unique addressable URI represents addressing at the universe, galaxy, constellation, or astronomical body degree of specificity.

### Registered Electronic Message Network and Application

In some embodiments, the methods, systems, software, applications, networks, and platforms disclosed herein include a software module for configuring electronic message boxes, or use of the same. In further embodiments, a secure electronic message box is associated with a physical street address and is addressable by a unique URI, based thereon, described herein. In one embodiment, operation of a software module for configuring secure electronic message boxes addressable by URIs based on physical street addresses forms a secure, registered electronic messaging network.

In some embodiments, the electronic message boxes described herein are secure messaging capable. In further embodiments, secure messaging is a server-based approach to protect sensitive data when sent outside a protective firewall. In further embodiments, secure messaging provides for authenticated exchanges and non-repudiation as the recipients are personally identified (e.g., verified) and transactions are logged by a secure email network or platform.

In some embodiments, the electronic message boxes described herein are registered messaging capable. In further embodiments, registered messaging is a messaging approach requiring a verified chain of custody including personal identification (e.g., verification) of the recipient(s) upon delivery. In still further embodiments, a sender of a registered electronic message receives a delivery confirmation indicating the recipient(s) of the message.

In some embodiments, a secure electronic message box is capable of receiving electronic messages directed to a physical street address or to, for example, an individual, group, entity, company, space, or object associated with the address. In further embodiments, a secure electronic message box receives electronic messages addressed to a unique URI based on a physical street address as described further herein. In still further embodiments, a unique URI includes user verification information, such as a user name, for an individual recipient associated with the physical street address. See e.g., FIGS. 3 and 4.

In some embodiments, a secure electronic message box is capable of sending electronic messages originating from a physical street address or from, for example, an individual, group, entity, company, space, or object associated with the address. In further embodiments, a secure electronic message box sends electronic messages addressed from a unique URI based on a physical street address as described further herein. In still further embodiments, a unique URI includes user verification information, such as a user name, for an individual sender associated with the physical street address. See e.g., FIGS. 3 and 4.

In some embodiments, the hierarchy of the elements of the URI formed by a TLD and secondary domains creates a scalable specificity for receiving and sending electronic messages. In further embodiments, a secure, registered electronic messaging network described herein includes scalable hierarchies of electronic message boxes. In some embodiments, an electronic message is addressed to recipients associated with, for example, a city, a street, a street address, a building, an apartment, and the like.

In some embodiments, the secure and/or registered electronic message boxes addressable by URIs based on physical street addresses described herein are integrated into a messaging application. In further embodiments, a messaging application is for instant messaging, email, and the like. In some embodiments, a messaging application is implemented as a standalone application or an executable. In some embodiments, a messaging application is implemented as a mobile application. In some embodiments, a messaging application is implemented as a web application or as SaaS.

The secure electronic message boxes, messaging applications, and secure, registered electronic messaging networks described herein are useful in a wide variety of industries, applications, and situations requiring or calling for secure messaging and/or registered messaging. In further embodiments, secure messaging and/or registered messaging provides compliance with regulations concerning privacy and security including, by way of non-limiting example, the Health Insurance Portability and Accountability Act of 1996 (HIPAA), the Gramm-Leach-Bliley Act or the Financial Services Modernization Act of 1999 (GLBA), and the Sarbanes-Oxley Act of 2002 (SOX).

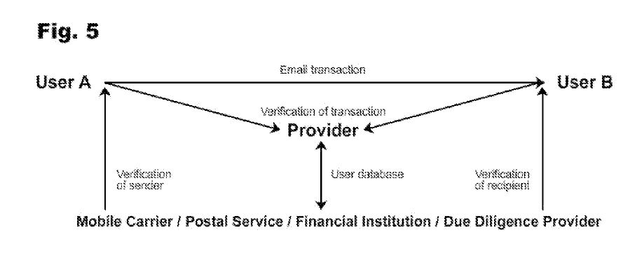

Referring to FIG. 5, in a particular non-limiting embodiment, an email transaction between User A (e.g., a sender) and User B (e.g., a recipient) is verified by a secure, registered electronic messaging network provider. In this embodiment, the provider obtains the sending and receiving URIs and verifies the identity of the sender(s) and the recipient(s) by comparing them to a user database. Further in this embodiment, the provider shares user verification information with, for example, a mobile carrier, a postal service, a financial institution, or a due diligence provider at either end of the email transaction.

In some embodiments, the secure and/or registered electronic message boxes addressable by URIs based on physical street addresses described herein are used for emergency messaging. In further embodiments, electronic message boxes are used for AMBER alerts, weather alerts, fire alarms, and other types of emergency messaging.

### Hyperlocal Forum Network and Application

In some embodiments, the methods, systems, software, applications, networks, and platforms disclosed herein include a software module for configuring a hyperlocal forum, or use of the same. In further embodiments, a hyperlocal forum is associated with a physical street address. In still further embodiments, a hyperlocal forum is web-accessible by unique addressable URI based on a physical street address described herein. In one embodiment, operation of a software module for configuring hyperlocal forums addressable by URIs based on physical street addresses forms a hyperlocal forum network.

In some embodiments, the hierarchy of the elements of the URI formed by a TLD and secondary domains creates a scalable specificity for viewing and posting to hyperlocal forums. In further embodiments, a hyperlocal forum network described herein includes scalable hierarchies of forums, such as wikis, message boards, and bulletin boards. In some embodiments, a hyperlocal electronic forum is associated with, for example, a city, a street, a street address, a building, an apartment, and the like. In further embodiments, a hyperlocal forum comprises a map indicating the location of the physical street address associated with the forum. In still further embodiments, a hyperlocal forum comprises communication tools.

In some embodiments, a hyperlocal forum is a wiki. In further embodiments, a wiki is a website wherein users optionally add, modify, or delete its content via a web browser using a simplified markup language or a rich-text editor. In some embodiments, a hyperlocal wiki enables a community to write documents collaboratively, using a simple markup language and a web browser. In such embodiments, a hyperlocal wiki allows users to create non-linear, evolving, complex and networked text, argument and interaction relevant to a particular physical street address or, for example, an individual, group, entity, company, space, or object associated with the address. In some embodiments, a hyperlocal wiki is open to alteration by the general public without requiring verification or registration. In other embodiments, a hyperlocal wiki is a private wiki requiring verification that a user is properly associated with a particular physical street address to edit pages, and in some cases to read pages.

In some embodiments, a hyperlocal forum is a message board. In further embodiments, a message board is an online discussion site where users hold conversations in the form of posted messages. In still further embodiments, messages are temporarily, semi-permanently, or permanently archived. In some cases, a message board is moderated. In other cases, a message board is unmoderated. In some cases, a message board is threaded. In other cases, a message board is not threaded. In some embodiments, a hyperlocal message board is hierarchical and in some cases contains one or more subforums, each of which may have several topics. In some embodiments, a hyperlocal message board is open to the general public without requiring verification or registration. In other embodiments, a hyperlocal message board is private and requires verification that a user is properly associated with a particular physical street address to post messages, and in some cases to read messages.

In some embodiments, a hyperlocal forum is a bulletin board system (BBS). In further embodiments, a BBS is an online service allowing users to upload and download software and data, read news and bulletins, and exchange messages with other users either through email or in public message boards. In some embodiments, a hyperlocal BBS is open to the general public without requiring verification or registration. In other embodiments, a hyperlocal BBS is private and requires verification that a user is properly associated with a particular physical street address to participate.

In some embodiments, the hyperlocal forums addressable by URIs based on physical street addresses described herein are integrated into a forum application. In further embodiments, a forum application is for discussion, conversation, file exchange, and the like. In some embodiments, a forum application is implemented as a standalone application or an executable. In some embodiments, a forum application is implemented as a mobile application. In some embodiments, a forum application is implemented as a web application or as SaaS.

The hyperlocal forums, forum applications, and forum networks described herein are useful in a wide variety of industries, applications, and situations requiring or calling for organized communication, discussion, or exchange of materials. In further embodiments, a hyperlocal forum enables convenient communication on topics relevant to a particular physical street address or an individual, group, entity, company, space, or object associated with the address. In some embodiments, the hyperlocal forums described herein are used for emergency communications. In further embodiments, forums are used for AMBER alerts, weather alerts, fire alarms, and other types of emergency messaging.

### Micropayment Network and Application

In some embodiments, the methods, systems, software, applications, networks, and platforms disclosed herein include software modules to identify payers and/or recipients of online or mobile micropayments, or use of the same. In further embodiments, a payer and a recipient are each identified with a unique addressable URI described herein. In still further embodiments, a payer and a recipient are each identified with a unique addressable URI based on a physical street address. In further embodiments, the methods, systems, software, applications, networks, and platforms disclosed herein include a software module for conducting a mobile payment or a micropayment between a verified payer and a verified recipient, or use of the same. In some embodiments, a micropayment is a financial transaction generally involving a small sum of money and generally occurring online. In further embodiments, a micropayment is a microdonation or a microtransaction.

In some embodiments, the user verification and micropayment modules described herein are integrated into a micropayment application. In further embodiments, a micropayment application is for micropayments, microtransactions, microdonations, and/or the like. In some embodiments, a micropayment application is implemented as a standalone application or an executable. In some embodiments, a micropayment application is implemented as a mobile application. In some embodiments, a micropayment application is implemented as a web application or as SaaS.

### User Identity Verification Network and Application

In many instances, users of online applications and services are anonymous. Even where identity is stated, it is often not verified, being merely based on a user created screen name or pseudonym. A screen name can reveal or include a user's legal name, but in existing systems, online identity is not tied to a physical street address.

In some embodiments, the methods, systems, software, applications, networks, and platforms disclosed herein include a software module configured to verify a user's identity, or use of the same. In further embodiments, a software module configured to verify a user's identity receives a request for verification along with a unique addressable URI described herein based on a physical street address, where the URI includes user identity information. In still further embodiments, a software module configured to verify a user's identity compares physical street address and username information obtained from a URI described herein to a known verified source of information. In some embodiments, a software module configured to verify a user's identity receives and/or sends an anonym secured verified key described further herein to allow identity verification without broadcast of sensitive personal information.

In some embodiments, a software module configured to verify a user's identity uses a unique addressable URI described herein based on a physical street address, where the URI includes user identity information to store, access, edit or retrieve further user identity information including, by way of non-limiting examples, personal identity, address, banking information, social security number, driver's license number, employment information, and the like. In further embodiments, a user verification module uses an anonym secured verified key to store, access, edit or retrieve further user identity information.

In some embodiments, the user verification modules described herein are integrated into a user identity verification application used to implement a user identity verification service. A user identity verification application or service is useful for any situation where authentication of a user's identity is recommended or required. In further embodiments, a user identity verification application is utilized for, for example, determining authority to send and/or receive registered electronic messages, determining authority to post to or administer a hyperlocal forum, determining authority to send and/or receive micropayments, conducting financial transactions, and/or the like. In some embodiments, a user identity verification application is implemented as a standalone application or an executable. In some embodiments, a user identity verification application is implemented as a mobile application. In some embodiments, a user identity verification application is implemented as a web application, as SaaS, or as a web service.

### Anonym Secured Verified Key

In some embodiments, the methods, systems, software, applications, networks, and platforms disclosed herein utilize unique addressable URIs based on physical street addresses and user information associated with the addresses, wherein the address and user information is clear and human-readable. In other embodiments, the physical street addresses and user information is encoded, encrypted, obfuscated, and/or anonymized to protect sensitive information. In some embodiments, the methods, systems, software, applications, networks, and platforms disclosed herein include a software module configured to apply hash functions to unique addressable URIs based on physical street addresses to produce an anonym secured verified key (e.g., a public verified key). In further embodiments, the methods, systems, software, applications, networks, and platforms disclosed herein utilize anonym secured verified keys to send, exchange, and receive physical street address information and associated user data securely.

A hash function is an algorithm or subroutine that maps large data sets of variable length, (e.g., keys), to smaller data sets of a fixed length. For example, a user's name, having a variable length, could be hashed to a single integer. The values returned by a hash function are called, for example, hash values, hash codes, hash sums, checksums or simply hashes. In some embodiments a software module configured to apply hash functions to the unique addressable URIs described herein applies one or more hash functions to user data or user information included in the URI. In some embodiments, the software module applies one or more hash functions to physical street address information included in the URI. In still further embodiments, the software module applies one or more hash functions to both the user information and address information included in the URI to produce an anonym secured verified key.

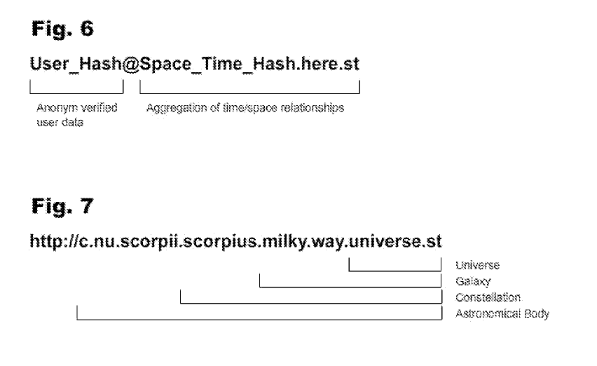

Referring to FIG. 6, in a particular embodiment, a URI includes aggregation of time and space relationships to which a hash function has been applied to create a space/time hash. In this embodiment, a URI includes user data to which a hash function has been applied to create a user hash. In total, the hashed URI comprises an anonym secured verified key. In some embodiments, use of space/time hashes enables secured platform transactions with the help of trusted third parties such as user identity verification service providers.

The public anonym secured verified keys described herein are useful in a wide variety of applications. In some embodiments, such a public key is used, for example, in verifying a user's identity, providing a user identity verification service, and/or creating a user identity verification application. In some embodiments, such a public key is used, for example, in routing electronic messages associated with a physical street address, providing a registered electronic message network, and/or creating a registered electronic message application. In some embodiments, such a public key is used, for example, in providing hyperlocal forums associated with a physical street address, providing a hyperlocal forum network, and/or creating a hyperlocal forum application. In some embodiments, such a public key is used, for example, in verifying senders and recipients of micropayments, providing a verified micropayment network, and/or creating a verified micropayment application. In some embodiments, such a public key is used, for example, in verifying an online user's identity, providing a user identity verification service, and/or creating a user identity verification application.

### Educational Resource Application

In some embodiments, the methods, systems, software, applications, networks, and platforms disclosed herein include a software module for configuring educational resources, or use of the same. In further embodiments, an educational resource is associated with an address or location and is addressable by a unique URI, based thereon, described herein. In still further embodiments, an educational resource is associated with an astronomical location (e.g., the location of an astronomical system, object, or body) and is addressable by a unique URI, based thereon, described herein.

In some embodiments, an educational resource comprises media. Many types of media are suitable. In some embodiments, suitable media include any media that facilitates communication of information to a user about a location and/or address or a system, object, person, place, or entity associated with the location and/or address. In further embodiments, suitable media include any media that facilitates a user's asking questions about a location and/or address or a system, object, person, place, or entity associated with the location and/or address. In still further embodiments, suitable media include any media that facilitates a user's sharing information about a location and/or address or a system, object, person, place, or entity associated with the location and/or address. In various embodiments, suitable media include, by way of non-limiting examples, text, photographs, illustrations, charts, tables, graphs, maps, audio, video, multimedia, interactive elements, games, and combinations thereof.

Many formats are suitable for an educational resource. In some embodiments, suitable formats include any format that facilitates communication of information to a user about a location and/or address or a system, object, person, place, or entity associated with the location and/or address. In further embodiments, suitable formats include any format that facilitates a user's asking questions about a location and/or address or a system, object, person, place, or entity associated with the location and/or address. In still further embodiments, suitable formats include any format that facilitates a user's sharing information about a location and/or address or a system, object, person, place, or entity associated with the location and/or address. In various embodiments, suitable formats include, by way of non-limiting examples, online classrooms, e-learning environments, social networks, wikis, blog, BBSs, message boards, audio sharing applications, audio galleries, photo sharing applications, photo galleries, video sharing applications, video galleries, web pages, web sites, articles, e-books, encyclopedia entries, interactive activities, games, internet television channels, internet radio stations, and the like.

### Browser Application

In some embodiments, the methods, systems, software, applications, networks, and platforms disclosed herein include a physical world browser, or use of the same. In further embodiments, a physical world browser provides a user interface to access one or more of the applications and networks utilizing the unique addressable URIs protocols and syntaxes based on physical addresses described herein. In some embodiments a physical world browser is a web browser or mobile web browser accessing applications and networks via, for example, the internet, the web, the cloud, an intranet, or via a storage device. In other embodiments a physical world browser is a web site portal accessing applications and networks offered as SaaS.

### Bar Codes

In some embodiments, the methods, systems, software, applications, networks, and platforms disclosed herein include a bar code resolving to the unique addressable URIs described herein, or use of the same. In some embodiments, a barcode is an optical machine-readable representation of data. Many types of bar codes are suitable. In some embodiments, a suitable bar code is a linear (e.g., one-dimensional) bar code. In further embodiments, a bar code is a Universal Product Code (UPC) bar code. In other embodiments, a suitable bar code is a two-dimensional bar code. In further embodiments, a bar code is a quick response code or QR Code®, Datamatrix code, or High Capacity Color Barcode (HCCB).

The bar codes resolving to unique addressable URIs described herein are used, for example on business cards. By way of further example, the bar codes described herein are human friendly QR codes used to semi-permanently create a reference to locations inside a vCard with the full name, address, and phone number for a location. In another example, the bar codes described herein further include plain text of the URI and are adhered to a store window.

In some embodiments, a two-dimensional bar code resolving to an addressable URI scheme is accompanied by a wireless electronic identifier in the form of a radio-frequency identification (RFID) or near field communication (NFC) tag that is readable by other devices with or without user interaction, to track the positioning of an object without radio/GPS signal. In some embodiments, the bar codes described herein are printed on a NFC tag.

### Digital Processing Device

In some embodiments, the methods, systems, software, applications, networks, and platforms described herein include a digital processing device, or use of the same. In further embodiments, the digital processing device includes one or more hardware central processing units (CPU) that carry out the device's functions. In some embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile OS®, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the methods, systems, software, applications, networks, and platforms disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the methods, systems, software, applications, networks, and platforms disclosed herein include at least one computer program. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the methods, systems, software, applications, networks, and platforms disclosed herein include software, server, and database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

The following illustrative examples are representative of embodiments of the software applications, systems, and methods described herein and are not meant to be limiting in any way.

### Example 1

A user registers their name, personal information, and address with a service provider offering online user identity verification. The user's name is Sean Kean and his address is 345 Eldert Street, Apartment 309, Brooklyn, New York, N.Y. 11237, United States of America. The registration process requires them to present proof of their identity and their current address of residence. Once registration is completed, the service provider's software agents automatically configure a registered email box for the user and a hyperlocal forum associated with the user's address. The URI used to address the email box is based on the user's verified identity and address:

sean.kean@345.eldert.street.apt.309.brooklyn.new.york.america.st.

The email box is a registered mail box. Messages sent to the mail box can be verified as having been sent to the user. Furthermore, message sent from the mail box can be verified as having come from the user.

The URI used to access the forum is similarly:

http://345.eldert.street.apt.309.brooklyn.new.york.america.st.

The forum is a wiki associated with the street address. Here, the user and his neighbors discuss local events and issues affecting his community.

### Example 2

A web user hears a news report about the recent discovery and study of a previously unknown star. The news report describes the star as the central star in the planetary nebula NGC 6302 (also called the Bug Nebula). The user types the following URI into her mobile browser:

http://central.star.bug.nebula.scorpius.milky.way.universe.st.

The URI is human-readable and based on the astronomical location of the star and represents the hierarchical nesting of increasingly specific location elements. The user is able to predict the URI based on her own basic knowledge of astronomy and the information in the news report. The URI points to an educational resource added to a network of resources by the National Aeronautics and Space Administration (NASA). The educational resource is in the form of an article about the star.

The user reads the article and observes a gallery of photographs of the nebula taken by the Hubble Space Telescope (HST). She learns that the star's surface temperature is estimated to be about 400,000 degrees Fahrenheit, making it one of the hottest known stars in our galaxy. She also learns that the star has a mass of 0.64 solar masses, has ceased nuclear burning, and is on its way to becoming a white dwarf, fading at a predicted rate of 1% per year.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. Non-transitory computer readable storage media encoded with a computer program including instructions executable by a digital processing device to create a registered electronic message application comprising:
a. a software module configured to access a database of physical street addresses;
b. a software module configured to generate a unique addressable URI based on each said physical street address, wherein each said addressable URI comprises a path further comprising elements representing a continent or region, a country, a state or province, a city, a street, a street number, and optionally a local identifier; and
c. a software module for configuring a secure electronic message box addressable by each addressable URI, wherein each electronic message box is capable of receiving electronic messages associated with a physical street address.

2. The media of claim 1, wherein said path element representing a continent or region comprises a top-level domain.

3. The media of claim 2, wherein said path element representing a continent or region comprises a .ST top-level domain.

4. The media of claim 2, wherein said path elements representing a country, a state or province, a city, a street, and a street number comprise subdomains.

5. The media of claim 1, wherein said electronic message box is an email box or a secure messaging box.

6. The media of claim 1, wherein said unique addressable URI comprises user verification information.

7. The media of claim 1, wherein said path comprises an element representing a person, place, or entity associated with the physical street address.

8. The media of claim 1, wherein said path comprises an aggregation of time and space relationships.

9. The media of claim 1, wherein said application further comprises a software module configured to generate a two-dimensional bar code resolving to each said addressable URI.

10. Non-transitory computer readable storage media encoded with a computer program including instructions executable by a digital processing device to create a hyperlocal forum application comprising:
a. a software module configured to access a database of physical street addresses in a computer memory;
b. a software module configured to generate a unique addressable URI based on each said physical street address, wherein each said addressable URI comprises a path further comprising elements representing a continent or region, a country, a state or province, a city, a street, a street number, and optionally a local identifier; and
c. a software module for configuring a hyperlocal forum associated with each physical street address, wherein each forum is web-accessible by at least one of the addressable URIs.

11. The media of claim 10, wherein said path element representing a continent or region comprises a top-level domain.

12. The media of claim 11, wherein said path element representing a continent or region comprises a .ST top-level domain.

13. The media of claim 11, wherein said path elements representing a country, a state or province, a city, a street, and a street number comprise subdomains.

14. The media of claim 10, wherein said hyperlocal forum is a bulletin board system.

15. The media of claim 10, wherein said hyperlocal forum is a wiki.

16. The media of claim 10, wherein said path comprises an aggregation of time and space relationships.

17. The media of claim 10, wherein said application further comprises a software module configured to generate a two-dimensional bar code resolving to each said addressable URI.

18. Non-transitory computer readable storage media encoded with a computer program including instructions executable by a digital processing device to create a user identity verification application comprising:
a. a software module configured to access a database of physical street addresses and users associated with each physical street address;
b. a software module configured to receive a request for verification of a user, wherein the user is identified with a unique addressable URI based on a physical street address, wherein said addressable URI comprises a user name and a path further comprising elements representing a continent or region, a country, a state or province, a city, a street, a street number, and optionally a local identifier; and
c. a software module configured to compare physical street address and username information from said database with information obtained from said URI to verify a user's identity.

19. The media of claim 18, wherein said path element representing a continent or region comprises a top-level domain.

20. The media of claim 19, wherein said path element representing a continent or region comprises a .ST top-level domain.
